(19) United States
(12) Patent Application Publication
(10) Pub. No.: US 2006/0145020 A1
(43) Pub. Date: Jul. 6, 2006

(54) Atmospheric entry thermal protection system

(76) Inventor: David Benjamin Buehler, Provo, UT (US)

Correspondence Address: David Buehler, 893 W 2150 N, Provo, UT, 84604, US

(21) Appl. No.: 11/301,573

(22) Filed: Dec. 12, 2005

Related U.S. Application Data
(60) Provisional application No. 60/634,865, filed on Dec. 10, 2004.

(51) Int. Cl. B64G 1/52

(52) U.S. Cl. 244/171.8

(57) ABSTRACT

A reusable system for reliably protecting a spacecraft from atmospheric entry heating is described. It includes a transpiration medium reservoir, apparatus for injecting transpiration medium through portions of the heat shield of the spacecraft, and a control system configured to inject a cleaning medium during the early portion of the launch and a transpiration cooling medium during reentry. Injecting a cleaning medium through the heat shield during ascent minimizes the likelihood of an insect or other debris clogging any of the transpiration pores.

This application claims the benefit of provisional application 60/634,865 filed Dec. 10, 2004 entitled “Atmospheric Entry Thermal Protection System”. It also references USPTO disclosure document number 548112 filed Feb. 27, 2004, entitled “Atmospheric Entry Thermal Protection System”.

### BACKGROUND OF THE INVENTION

1. Field of the Invention

The invention is directed to space vehicles and more particularly to reusable spacecraft which are launched into orbit, then return from orbit and substantially decelerate in the atmosphere. This invention relates to an improvement in for spacecraft to reliably protect them from the heat of entering an atmosphere at high velocity with a reusable system.

2. Description of Related Art

Presently, most spacecraft are not designed to be recovered. This is partly because it is difficult to return them to the surface of the earth, since they must lose at least 7 km/s of velocity to do so and the only practical way to do so is to slow down in the atmosphere, which generates extreme temperatures due to the friction of the spacecraft moving through the upper atmosphere at speeds starting at Mach 25. Without a system to block the heating the spacecraft would burn up like a meteor in the atmosphere.

The manned capsules flown by the US, Russians, and Chinese have utilized an ablative heat shield to protect the capsule from the heat of reentry. These systems are well understood and reliable when carefully designed. However, they can only be used once, thus precluding their use on a fully reusable spacecraft.

The Space Shuttle uses a reusable thermal protection system, and it uses high temperature ceramic materials for heat shielding to protect if from the heat of atmospheric entry. The system is reusable, but requires an lengthy inspection and repair process between flights which is very expensive.

Prior art transpiration systems inject a gas or liquid through pores in the vehicle's skin to block the hot gasses from over-heating the surface. These systems are similar to the ablative system, but in place of a ablative medium that vaporizes blocking convective heat transfer, a transpiration medium is injected through pores keeping the surface cool. Transpiration based systems have an advantage of being reusable and require only refilling of the storage reservoir, inspection and possibly testing. However, they have a disadvantage of being complex and must work perfectly for the spacecraft to survive entry. If a plumbing connection gets clogged or some of the pores become clogged due to an impact with a small piece of debris or insect during launch, a hot spot may develop, the substrate and skin of the spacecraft could overheat and the spacecraft would be lost.

What is needed is a system which is reliable and robust but is inexpensive and completely reusable without expensive amounts of refurbishment and inspection.

### SUMMARY OF THE INVENTION

The principle object of this invention is to provide an economical, reliable method by which to protect a spacecraft from heating during atmospheric entry.

The invention comprises a system of transpiration cooling pores with at least one reservoir of a transpiration medium. To prevent the pores from becoming clogged because of collisions with bugs and other debris during launch, the control system causes a cleaning medium to be injected through the pores during launch.

In one embodiment, the cleaning medium consists of peroxide that is decomposed prior to being vented through the transpiration pores. In another embodiment, it consists of a solvent mixed with water. This flushes out any debris that the vehicle may collide with and minimizes the chances that the debris will clog any of the transpiration pores.

Because the pore cleaning medium is injected during the early part of the flight, the added mass of carrying it does not have a large impact on the payload capability of the vehicle because it is jettisoned long before the rocket reaches orbit. Also, it is a simple system to add, requiring only a change to the control system if the transpiration medium is to be injected during launch, or an added reservoir and valve if medium is to be used that is not the same as the transpiration medium, compared to prior-art transpiration cooling systems.

In one embodiment, the transpiration-based heat shield is backed up with a prior-art ablative heat shield to further improve reliability. This adds to the mass of the system, but provides insurance that a failure of the transpiration cooling system would not result in the loss of the spacecraft. The combination gives the reliability benefit of an ablative system with the reusability of a transpiration based system. It allows a reusable vehicle to be flow frequently without expensive refurbishment between flights.

### SHORT DESCRIPTION OF DRAWINGS

FIG. 1A is a pictorial view of a spacecraft with a conical heat shield entering the atmosphere.

FIG. 1B is a pictorial drawing of a spacecraft with a blunt heat shield entering the atmosphere.

FIG. 1C is a cross-sectional view of the surface of a heat shield during atmospheric entry. This figure is missing.

FIG. 2 is a schematic cross sectional view of the heat shield apparatus of the present invention.

FIG. 3 is a cross-sectional view of the heat shield surface.

FIG. 4 is a schematic cross-sectional view of the heat shield apparatus of the present invention with a peroxide launch injection system.

FIG. 5 is a schematic flow chart of the heat shield control system of the present invention.

### DETAILED DESCRIPTION OF INVENTION

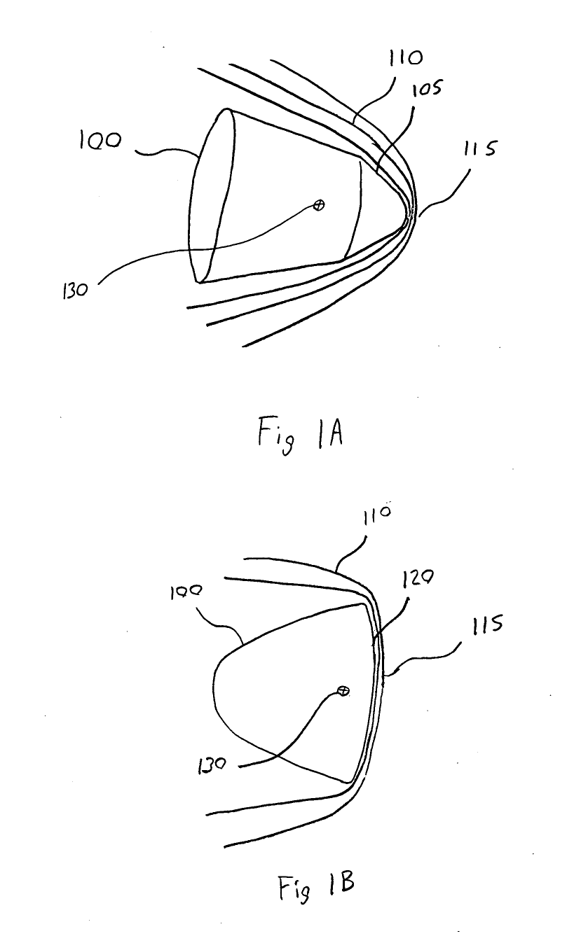

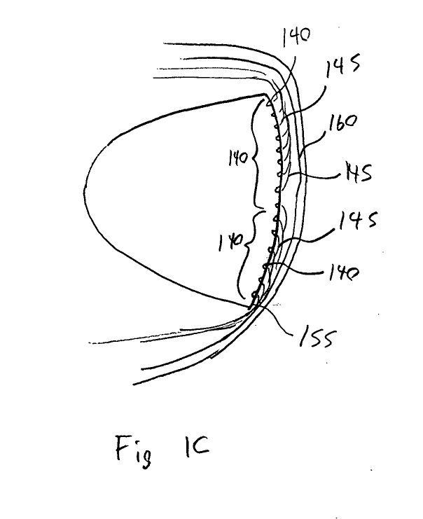

FIG. 1A is a pictorial drawing of a spacecraft with a prior-art conical heat shield entering the atmosphere. As depicted, the spacecraft (100) with a conical heat shield (105) is entering the atmosphere. The shockwave (110) flows over the heat shield. The center of mass (130) of the spacecraft if far enough forward that it is stable on atmospheric entry. The maximum heating on the heat shield is at the stagnation point (115) which is in the center of the nose. The heat shield must protect the spacecraft from the heat of the shock wave generated during high velocity movement through a planetary atmosphere. A conical body may be used to generate lift if the center of gravity is offset from the centerline of the vehicle.

FIG. 1B is a pictorial drawing of a spacecraft (100) with a prior-art blunt heat shield (125) entering a planetary atmosphere. As depicted, a spacecraft with a blunt heat shield (120) is entering a planetary atmosphere blunt-side first and the heat shield material protects the spacecraft from being vaporized by the heat. The blunt shape may be used to generate a modest amount of lift by offsetting the center of mass of the spacecraft. The shockwave (110) is generated over the front of the heat shield.

FIG. 1C shows a cross-sectional view of the surface of a prior-art transpiration-based heat shield during atmospheric entry. As depicted, the prior-art transpiration-based heat shield (155) has numerous pores (140), which are used to inject a cool layer of gas (145) used to protect the spacecraft (150) against the heat generated from the re-entry shock wave (160).

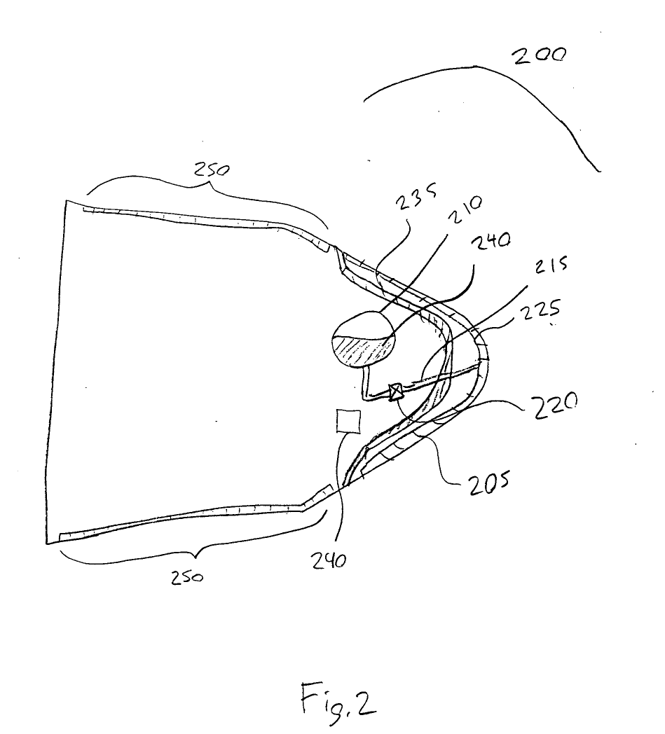

FIG. 2 is a schematic cross sectional view of the heat shield apparatus of the present invention. As depicted, the heat shield apparatus (200) includes a porous outer skin (205), a transpiration medium storage reservoir (210), a conduit (215) to conduct the transpiration medium (240) to the porous outer skin (205), a valve (220) to isolate the storage reservoir (210) from the heat shield surface, a dispersion plumbing (225) to disperse the transpiration medium to all points of the porous outer skin (205), and an ablative backup heat shield (235), and a control system (240).

In one embodiment, the pores are spaced between 0.5 mm to 3 mm apart depending on the expected local heat load. In another embodiment, the surface is made of a porous material through which the transpiration medium flows.

The transpiration medium storage reservoir (210) is where the water, gas, or other transpiration medium is stored. In one embodiment, leftover pressurant gas from the propellant tank is used as the transpiration medium. The medium storage reservoir comprises a positive expulsion bladder and pressurized gas to provide the pressure to expel the medium. Not shown (for simplicity of drawing) are the transpiration medium and pressure gas filler ports.

The dispersion plumbing (225) disperses the transpiration medium to all points of the surface so that each point on the surface receives enough transpiration medium to keep the surface below the maximum safe temperature. The medium does not need to be dispersed evenly; for example the nose might receive medium at a higher flow rate per unit area because of the high local heat loads experienced there.

In one embodiment, the aft body is protected by a reusable thermal protection material such as ceramic tiles or high-temperature resistant metal skin (250) because this portion of the spacecraft is subjected to less intense re-entry heat. The transpiration cooling effect also serves to reduce the heat loads the aft body experiences.

The ablative heat shield device (235) protects the spacecraft from a failure of any type in the transpiration portion of the system, so the spacecraft will be reliably protected from the re-entry heat. It is constructed using standard ablative heat shield technology, such as a phenolic high-temperature-fiber composite.

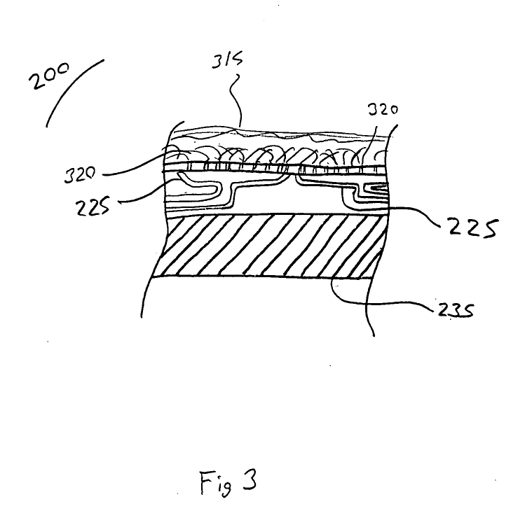

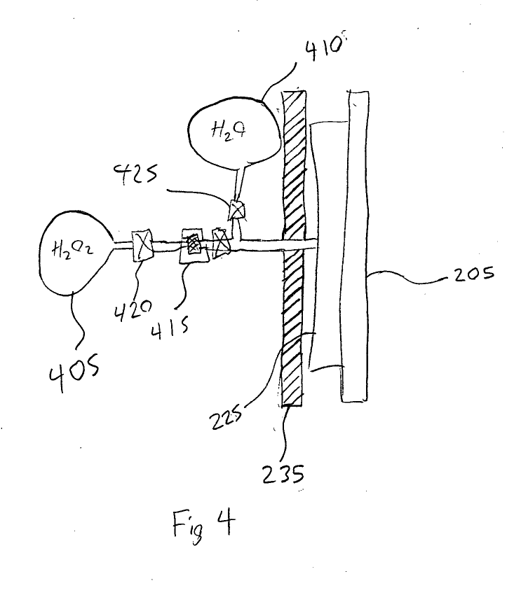

FIG. 3 is a cross-sectional view of the heat shield (200) of the present invention. As depicted, the heat shield (200) includes a porous outer skin (205), a transpiration medium dispersion mechanism (225), the ablative backup heat shield (235). Also shown is the shock layer (315) and the cool gas layer (320). The relatively cool injected gas exiting the pores (330) protects the surface convectively transferred heat from the shock wave. The transpiration medium also absorbs heat as it passes through the porous skin and carries it away from the vehicle.

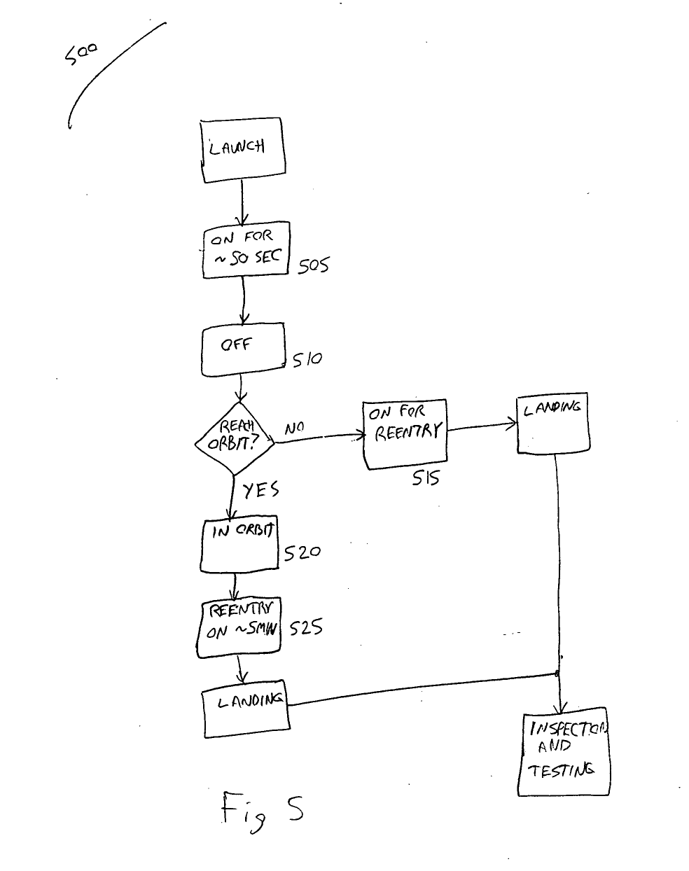

FIG. 4 is a schematic cross-sectional view of the heat shield apparatus of the present invention with the cleaning medium injection system of the present invention. As depicted, the heat shield apparatus with cleaning medium injection system includes a cleaning medium storage reservoir (405), a transpiration cooling medium storage reservoir (410), an optional peroxide decomposition module (415), a valve (420) to isolate the cleaning medium storage reservoir (405) from the heat shield surface, a valve (425) to isolate the transpiration medium storage reservoir, a dispersion plumbing system (225) to disperse the transpiration medium to all points of the porous out skin (205), and an ablative backup heat shield (235). The cleaning medium is injected during the early portion of the flight. It flushes away and dissolves debris and insects that impact the vehicle in early flight. In one embodiment, the cleaning medium comprises a solution of hydrogen peroxide and water, functions as a cleaning medium. The peroxide mixture is decomposed into oxygen gas and steam in the optional peroxide decomposition module (415) before being injected through the heat shield. The decomposed peroxide serves to minimize the chances of impact with debris because it exits the surface at a high velocity because of its low density. It also cleans away organic material because of the oxygen content and temperature.

FIG. 5 is a schematic flow chart of the heat shield control system of the present invention. As depicted, the flow chart (500) shows how the heat shield control system is operated. The transpiration is turned on during the early portion of the ascent (505). In an embodiment comprising an additional cleaning medium, it is injected during this phase. The system is turned off during the remainder of the ascent (510), optionally turned back on if the stage does not reach orbit and reenters prematurely (515), stays off during times spent in space (520), and finally is turned on for entry into the atmosphere (525). This prevents collisions with insects and other debris during launch from clogging pores and from causing overheating problems during reentry.

While the invention has been described in the specification and illustrated in the drawings with reference to a main embodiment and certain variations, it will be understood that these embodiments are merely illustrative. Thus those skilled in the art may make various substitutions for elements of these embodiments, and various other changes, without departing from the scope of the invention as defined in the claims. Therefore, it is intended that the invention not be limited to the particular embodiment illustrated by the drawings and described in the specification as the best mode presently contemplated for carrying out this invention, but that the invention will include any embodiments falling within the spirit and scope of the appended claims.

We claim:

1. A system for reliably protecting a spacecraft from atmospheric entry heating, comprising:
a transpiration cooling medium storage reservoir;
a pressurization system configured to urge the transpiration medium through the skin of the vehicle;
a valve configured to isolate transpiration medium storage reservoir;
a transpiration control system configured to:
1) flow transpiration cooling medium through the heat shield early portion of the launch,
2) flow transpiration cooling medium through the heat shield during reentry into the atmosphere.

2. The system claimed in claim 1, wherein early portion of the launch is defined as up to 60 seconds of flight.

3. The system claimed in claim 1, wherein the transpiration medium is selected from the group consisting of: 1) water 2) pressurant gas 3) peroxide 4) water and peroxide.

4. The system claimed in claim 1, wherein the system further comprises a second source of liquid water and peroxide that is connected to the transpiration passages through a conduit and valve, and this solution is urged through the skin during ascent.

5. The system claimed in claim 1, wherein the system further comprises a second source of liquid water and peroxide is connected to the system through a conduit and valve and a decomposition chamber, and decomposed peroxide and steam is urged through the skin during ascent.

6. The system claimed in claim 1, wherein the thermal protection system further comprises an ablative heat shield located under the transpiration cooling layer capable of protecting the spacecraft should the transpiration cooling system suffer a failure.

7. A system for reliably protecting a spacecraft from atmospheric entry heating, comprising:
a transpiration cooling medium storage reservoir;
a cleaning medium storage reservoir;
a pressurization system configured to urge the transpiration medium and cleaning medium through the skin of the vehicle;
a valve to isolate transpiration medium reservoir;
a valve to isolate the cleaning medium reservoir;
a control system configured to:
1) inject a cleaning medium during the first portion of the launch,
2) inject transpiration cooling medium during reentry into the atmosphere.

8. The system claimed in claim 1, wherein early portion of the launch is defined as up to 60 seconds of flight.

9. The system claimed in claim 1, wherein the transpiration medium is selected from the group consisting of: 1) water 2) pressurant gas 3) peroxide 4) a mixture of water and peroxide.

10. The system claimed in claim 1, wherein the system further comprises a second source of liquid water and peroxide that is connected to the transpiration passages through a conduit and valve, and this solution is urged through the skin during ascent.

11. The system claimed in claim 1, wherein the system further comprises a second source of liquid water and peroxide is connected to the system through a conduit and valve and a decomposition chamber, and decomposed peroxide and steam is urged through the skin during ascent.

12. The system claimed in claim 1, wherein the thermal protection system further comprises an ablative heat shield located under the transpiration cooling layer capable of protecting the spacecraft should the transpiration cooling system suffer a failure.

13. A method for protecting a space vehicle during entry into a planetary atmosphere, comprising:
injecting a first medium through a porous skin during portion of the ascent that is low in the atmosphere to minimize chances airborne debris will clog a porous portion of the skin; and,
injecting a second medium through a porous skin during atmosphere entry to minimize the convective heat transfer from the hot shock wave to the spacecraft skin.
